(19) United States
(12) Patent Application Publication
(10) Pub. No.: US 2013/0105074 A1
(43) Pub. Date: May 2, 2013

(54) METHODS FOR MANUFACTURING A DUAL BIOSENSOR TEST STRIP

(71) Applicant: ROCHE DIAGNOSTICS OPERATIONS, INC., Indianapolis, IN (US)

(72) Inventors: Randall K. Riggles, Indianapolis, IN (US); Eric R. Diebold, Fishers, IN (US); Abner D. Joseph, Carmel, IN (US); Terry A. Beaty, Indianapolis, IN (US)

(73) Assignee: ROCHE DIAGNOSTICS OPERATIONS, INC., Indianapolis, IN (US)

(21) Appl. No.: 13/712,072

(22) Filed: Dec. 12, 2012

Related U.S. Application Data
(63) Continuation of application No. PCT/US2011/042574, filed on Jun. 30, 2011.
(60) Provisional application No. 61/360,010, filed on Jun. 30, 2010.

(51) Int. Cl. G01N 27/327

(52) U.S. Cl. CPC G01N 27/327
USPC 156/269; 427/2.12

(57) ABSTRACT

Some embodiments of the invention include a 2-up manufacturing technique for producing test strips to reduce costs, reduce waste, and increase output. Other techniques relating to the 2-up technique, such as simultaneously manufacturing test strips arranged in multiple columns, are also disclosed. Yet other techniques include cutting through the upper and lower substrates to form an overhang of either the upper or the lower substrate. Other embodiments include a dual-use biosensor in which a user can apply a sample of bodily fluid to both test strips simultaneously.

### CROSS-REFERENCE TO RELATED APPLICATIONS

This application is a continuation of International Application No. PCT/US2011/042574 filed Jun. 30, 2011, which claims the benefit of U.S. Provisional Patent Application No. 61/360,010 filed Jun. 30, 2010.

### BACKGROUND

In many fields of healthcare, repeated measurement and monitoring of certain analytes present in bodily fluids, such as blood or urine, is of particular importance. One special case concerns, for example, patients affected by diabetes who need to measure the concentration of glucose very frequently in order to respond promptly with the correct medication. Exceeding certain blood glucose limits can result in coma or death. Even mildly elevated levels of blood glucose can result in gradually deteriorating health requiring long term monitoring to keep glycemic levels under control. As such, blood glucose data are useful both to the physician who has the task to determine the most appropriate long-term therapy, and to the patient who daily needs to adapt the administration of medications according to the measured glucose levels. These depend not only on the diet, but also on the daily physical activity and many other factors, which influence the metabolism.

A number of small, reliable and low-cost medical devices, which can be handheld, are available today to the patient for self monitoring. Devices for controlled administration of therapeutic agents, such as insulin pumps, are also commercially available. The number of exemplary medical devices to which this invention refers to is, however, not limited to diabetes care. Worth mentioning are, for example, those devices for monitoring blood pressure or other blood parameters like coagulation factors.

### SUMMARY

A new test strip provides opportunities for improvements in biosensors as well as in their production. As generally contemplated, a test strip can be used in monitoring various disorders, such as diabetes, since it can test fluid samples for the presence or concentration of an analyte, such as blood glucose. The test strip includes a capillary chamber for receiving a liquid sample and a vent. The sample chamber is bounded on the top and bottom by two substrate layers that are spaced apart by a spacing layer. At least one of the substrates is optionally clear (transparent or translucent) to allow the user to visually confirm dosing of the capillary chamber. Horizontally, the capillary chamber is bounded by a cutout portion of the spacing layer and an opening. The cutout portion in some embodiments is configured to provide the capillary chamber with an aspect ratio of the chamber depth to the chamber width that is optimized for fast sample filling.

Embodiments include a generally square-ended test strip with a wide sample application port where the user is able to easily and quickly dose a fluid sample. Non-square-ended embodiments, e.g. taper or round ended, provide similar advantageous dosing flexibility. The wider dosing location provided on the strip can be helpful for those with reduced eyesight, hand dexterity or hand stability difficulties. Embodiments also provide sample chambers that require small volumes of fluid for testing and fill rapidly with sample fluid. Other features include increasing manufacturing efficiencies and cost savings when producing test strips according to other embodiments. Some or all of these features may be present in the corresponding independent or dependent claims, but should not be construed to be a limitation unless expressly recited in a particular claim.

This summary is provided to introduce a selection of the concepts that are described in further detail in the detailed description and drawings contained herein. This summary is not intended to identify any primary or essential features of the claimed subject matter, nor is it intended to be used as an aid in determining the scope of the appended claims. Each embodiment described herein is not intended to address every object described herein, and each embodiment does not include each feature described. Other forms, embodiments, objects, advantages, benefits, features, and aspects of the present invention will become apparent to one of skill in the art from the detailed description and drawings contained herein.

### BRIEF DESCRIPTION OF THE DRAWINGS

FIG. 1 is a perspective view of a biosensor according to one embodiment.

FIG. 2 is a fragmentary perspective view of the fluid sampling end of the biosensor depicted in FIG. 1.

FIG. 3 is an exploded perspective view of the biosensor depicted in FIG. 1.

FIG. 4 is a plan view of the biosensor depicted in FIG. 1 inserted into a test meter.

FIG. 5 is a fragmentary, top plan view of the fluid sampling end of the biosensor depicted in FIG. 1 with a directional illustration of fluid entering the sample chamber.

FIGS. 6A, 6B, 6C and 6D are fragmentary, top plan views of the biosensor depicted in FIG. 1 sequentially illustrating a fluid sample entering the sample chamber.

FIG. 7 is an exploded, fragmentary view of a plurality of biosensors prior to lamination during a 2-up manufacturing process according to yet another embodiment.

FIG. 8 is an exploded, fragmentary view of a plurality of biosensors prior to lamination during a 2-up manufacturing process according to yet another embodiment employing a discrete reagent layer deposition method.

FIG. 9 is a fragmentary, sectional view of one of the test strip pairs depicted in FIG. 7 after lamination.

FIG. 10 is a fragmentary, sectional view of a test strip pair according to yet a further embodiment.

FIG. 11 is an exploded, fragmentary view of a plurality of biosensors prior to lamination during a 2-up manufacturing process according to yet another embodiment.

FIG. 12 is a fragmentary, sectional view of one of the test strip pairs depicted in FIG. 11 after lamination.

FIG. 13 is an exploded, fragmentary view of a plurality of biosensors prior to lamination during a 2-up manufacturing process according to yet another embodiment employing a discrete reagent layers over the electrode patterns of each of Column A and Column B.

FIG. 14 is a fragmentary, sectional view of one of the test strip pairs depicted in FIG. 13 after lamination and after preparation for use as a dual-use biosensor according to embodiments disclosed herein.

FIG. 15 is a fragmentary, sectional view of an alternative embodiment for making a dual-use biosensor.

FIG. 16 is a fragmentary, sectional view of a completed dual-use biosensor according to FIG. 15.

FIG. 17 is a fragmentary, cross sectional view of a single-cut singulation process for providing disparate overhang distances for the top layer and bottom layer substrates.

FIG. 18 is a fragmentary, cross sectional view of a two-cut singulation process for providing disparate overhang distances for the top layer and bottom layer substrates.

FIG. 19 is a fragmentary, cross sectional view showing the beveled end cuts and disparate overhang distances according to one embodiment.

FIG. 20 is a fragmentary, cross sectional view showing the beveled end cuts and disparate overhang distances according to another embodiment.

FIG. 21 is a top plan view of a test strip singulated from the sheet of test strips shown in FIG. 22.

FIG. 22 is a fragmentary, top plan view of a sheet of biosensors manufactured in a 2-up manufacturing process according to yet another embodiment.

### DETAILED DESCRIPTION OF THE ILLUSTRATED EMBODIMENTS

For the purposes of promoting an understanding of the principles of the invention, reference will now be made to the selected embodiments illustrated in the drawings and specific language will be used to describe the same. It will nevertheless be understood that no limitation of the scope of the invention is hereby intended, such alterations, modifications, and further applications of the principles of the invention being contemplated as would normally occur to one skilled in the art to which the invention relates. At least one embodiment of the invention is shown in great detail, although it will be apparent to those skilled in the relevant art that some features or some combinations of features may not be shown for the sake of clarity.

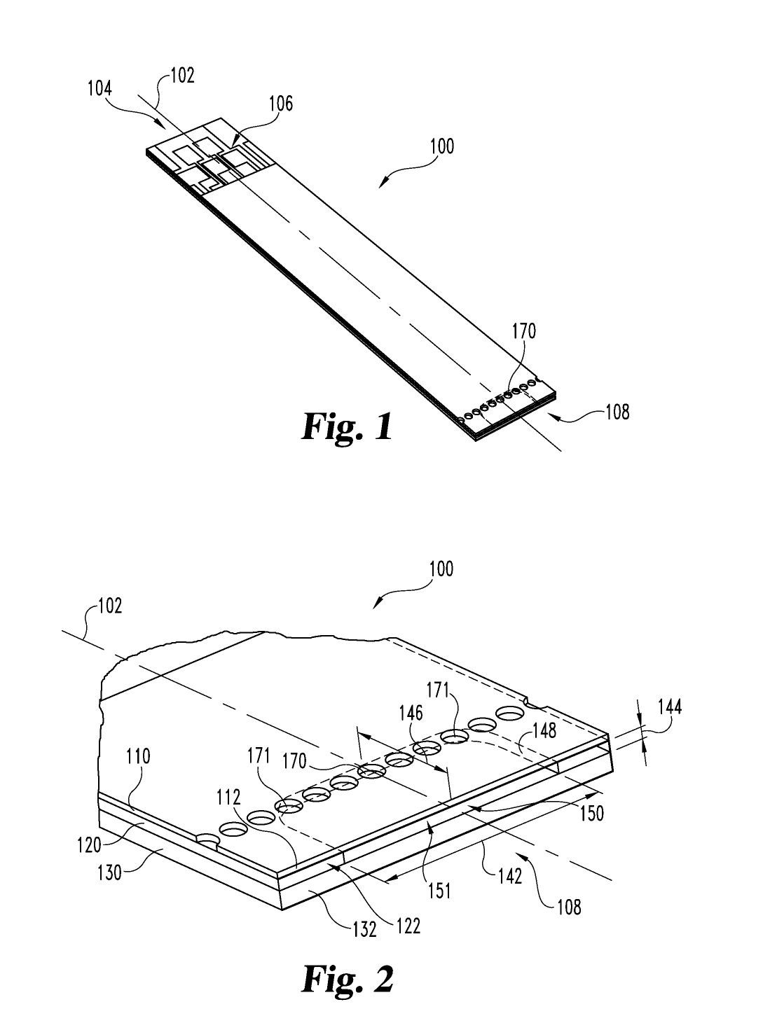

Depicted in FIG. 1 is a biosensor, for example a test strip 100, according to one embodiment. The test strip 100 is generally shaped as a flat, elongated rectangle defining a longitudinal axis 102. The test strip 100 includes a test meter connection end 104 with an electrode and contact pad pattern 106 that connects with a test meter for determining the concentration and/or presence of an analyte in a sample of bodily fluid. The test strip 100 further includes a fluid sampling end 108, which collects the sample of bodily fluid for testing.

Turning to FIG. 2, the test strip 100 further includes an upper substrate layer 110, a middle substrate layer (for example, a spacer 120), and a lower substrate layer 130. The spacer 120 is positioned vertically between the upper substrate layer 110 and the lower substrate layer 130. A sampling end 108 includes an upper substrate front edge 112 of the upper substrate layer 110. The spacer 120 includes a spacer front edge 122 that extends to the sampling end 108 as described below. Similarly, the sampling end 108 includes a lower substrate front edge 132 of the lower substrate layer 130.

The terms “upper” and “lower” (as well as similar terms such as “top” and “bottom”) are used for illustrative purposes in lieu of terminology such as “first” and “second” in an effort to make the description of the illustrated embodiments easier to read and comprehend without narrowing the scope of the embodiments disclosed herein. No directional preference is intended. For example, “first,” “second” and “lower” may alternatively be used instead of “upper,” and “second,” “first” and “upper” (respectively) may alternatively be used instead of “lower.” It is understood that the embodiments can be inverted, with the “upper” layer becoming the “bottom” layer and the “bottom” layer becoming the “upper” layer.

The term “front” is also used for illustrative purposes in an effort to make the description of the illustrated embodiments easier to read and comprehend without narrowing the scope of the embodiments disclosed herein. No directional preference is intended. For example, the term “edge” alone may alternatively be used instead of “front edge.” It is understood that the embodiments can be rotated, with the “front” becoming the “back.”

The spacer 120 includes a first cutout portion 148. When the test strip 100 is assembled, the first cutout portion 148 defines a sample chamber 150. The sample chamber 150 is sized to receive a fluid sample for testing. The sample chamber 150 is formed in a space provided by the cutout portion 148 between the upper substrate layer 110 and the lower substrate layer 130. A portion of the upper substrate layer 110 forms an upper border of the sample chamber 150 and a portion of the lower substrate layer 130 forms a lower border of the sample chamber 150. The sample chamber 150 includes an opening 151 at the sampling end 108. The dimensions of the sample chamber 150 include a height 144, a width 142 and a depth 146. In the illustrated embodiment, the area of the first cutout portion 148 exposes lower substrate layer 130 and a portion of electrodes thereon as described in more detail below. In the illustrated embodiment, the upper substrate layer 110 includes a vent opening 170 that is aligned with the sample chamber 150. Alternatively, in other embodiments, the lower substrate layer 130 includes a vent hole. Moreover, a vent opening for the sample chamber 150 is provided in any suitable manner. Some examples can include a hole aligned with the sample chamber 150 as described herein, or by a slot vent arrangement such as disclosed in U.S. Pat. No. 7,829,023, which is hereby incorporated by reference.

In yet another embodiment, vent opening 170 comprises a plurality of linearly spaced apart holes 171 in top substrate 110. Holes 171 may be provided in a transverse arrangement in the cover and spaced apart a maximum distance that is less than the width 142 of the sample chamber in order to facilitate registration of the vent over the cutout portion 148. As a result, registration of the vent opening 170 is only generally required in a longitudinal dimension because at least one hole 171 will always overlay the cutout portion 148, leaving only the alignment at the desired position relative to the depth of the sample chamber as a manufacturing concern.

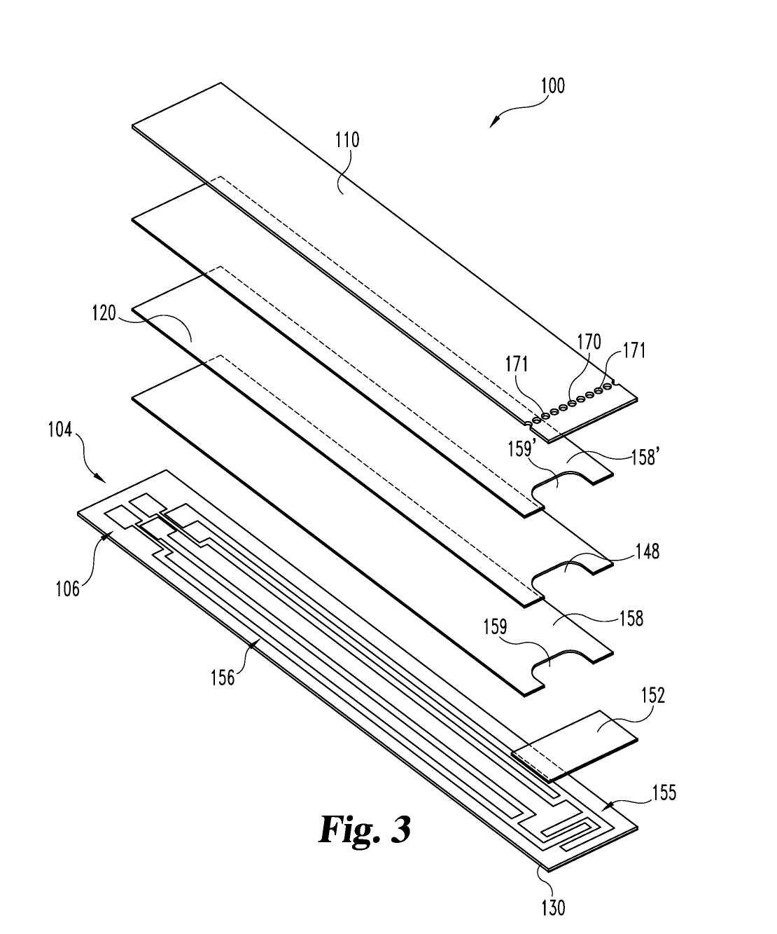

Referring to FIG. 3, the test strip 100 further includes a reagent, for example the reagent layer 152, which reacts with the fluid sample during testing. In the illustrated embodiment, the reagent layer 152 overlies and contacts an electrode pattern 155 that is formed at the sampling end 108. The electrode pattern 155 is formed in the sample chamber 150 and generally contacts the sample fluid directly during testing. The electrode pattern 155 is electrically connected to the contact pad pattern 106 at the test meter connection end 104 of the test strip 100 by the electrode traces 156. An adhesion layer 158 is positioned between the lower substrate layer 130 and the spacer 120, and binds the lower substrate layer 130 and the spacer 120 together. A second adhesion layer 158′ is positioned between and binds the upper substrate layer 110 and the spacer 120 together. Together the spacer 120 and first and second adhesion layers 158 and 158′ have a combined thickness sufficient to define the desired height 144 of the sample chamber 150. Moreover, the first and second adhesion layers 158 and 158′ have second cutout portions 159 and 159′ removed therefrom that are sized similarly to the first cutout portion 148. In one alternative embodiment, spacer 120 comprises a two-sided adhesive layer, such as a pressure-sensitive adhesive (or PSA), such that separate adhesion layers 158 and 158′ are not required. In such embodiments, the two-sided adhesive layer, such as a double sided tape, has a thickness sufficient to define the desired height 144 of the sample chamber 150.

Examples of adhesives that can be employed include pressure-sensitive adhesives, hot melt and other heat sealable adhesives, and cold sealable adhesives. In yet other embodiments, rather than using adhesion films or layers, the layers of the biosensor can be fixed together by heat or laser sealing according to such methods as are generally known in the art.

Depicted in FIG. 3 is one embodiment of an electrode pattern 155. The configuration of electrode pattern 155 is described in more detail below. The electrode pattern 155 is configured within the sample chamber 150 in any suitable manner, as is well known in the art. The electrode pattern 155 can be produced using, for example, broad field laser ablation techniques or other high-definition, high precision quality methods of forming electrode patterns, such can be achieved with the current state of the art in ink jetting techniques.

In one embodiment, broad field laser ablation is used in a reel to reel configuration to form multiple electrode patterns 155 with each laser pulse. That is, two or more adjacent patterns can be formed by a single laser pulse as a web of metalized substrate is wound through a laser ablation chamber. By forming multiple patterns with a single pulse, the throughput of the electrode forming step in the overall manufacturing process is increased. This can typically be achieved using known broad field laser ablation technology by providing an appropriate laser mask that includes the multiple electrode patterns (and thus is larger than a single-pattern mask), and a lens for directing the laser through the mask, which lens provides a broader dispersion of the laser to be sufficiently directed through the larger mask. This multiple pattern formation using a single pulse also provides advantages in the 2-up manufacturing process discussed further below.

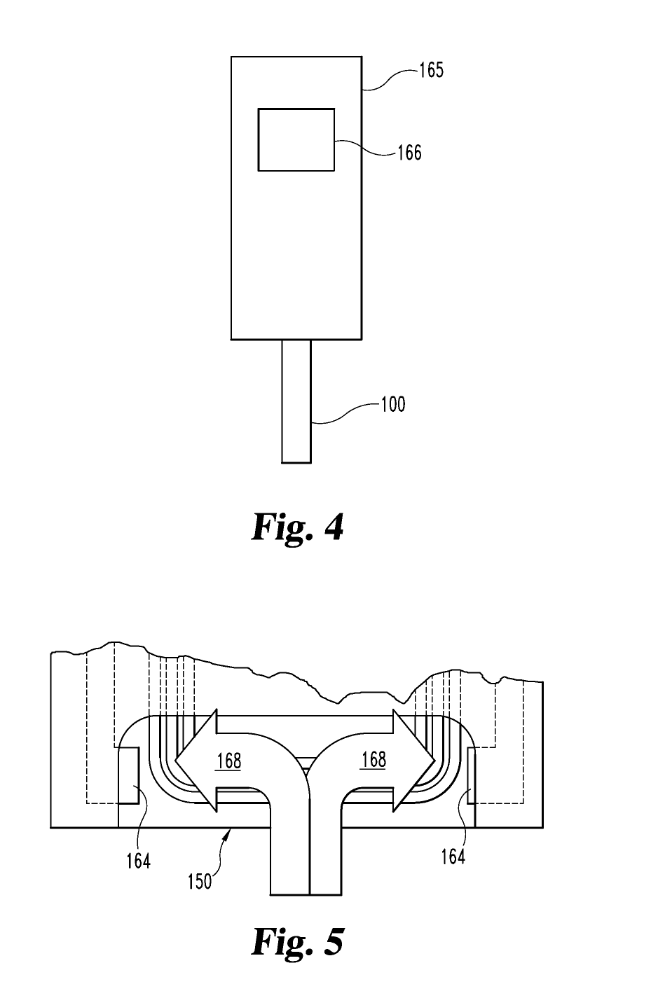

In use, a test meter connection end of a test strip 100 is inserted into a test meter 165 as depicted in FIG. 4. The test meter 165 includes a display 166 for providing information and/or directions to a user. A sample fluid is obtained, for example a blood or interstitial fluid sample obtained typically by penetrating the skin surface with a sharp object such as a lancet or a needle. As the sample fluid emerges from the wound, it collects on the surface of the skin and the user brings the droplet of sample fluid in contact with the opening 151 of the sample chamber 150. When the fluid contacts the opening 151 of sample chamber 150, the sample chamber 150 draws the fluid inward by capillary action.

As shown in the illustrated embodiment in FIG. 5, two sample sufficiency electrodes 164 may be provided within the sample chamber 150 in order to determine a sufficient amount of sample is dosed, using well known methods for operating these electrodes 164 for such purpose. The location and operation of the sufficiency electrodes 164 within the sample chamber 150 helps to ensure that testing does not begin (once the test strip is inserted into a meter) until the sample fluid fully covers the working electrode. That is, the sample fluid must bridge the gap between the sample sufficiency electrodes before analysis is allowed to begin, using known methods for electrically detecting such bridging by a fluid. It is well within the ordinary skill in the art to optimally locate the sample sufficiency electrodes 164 within the sample chamber 150 based on the configuration of the chamber 150, anticipated dosing flow patterns (see, e.g. FIG. 5), and configuration of the electrode pattern 155. The basic premise is to ensure that the sample sufficiency electrodes are not bridged by the sample fluid until the electrode pattern 155 is also covered by the sample fluid at least to the extent required to perform an accurate measurement. Thus, in a single flow front capillary, the electrodes 164 would be located completely downstream of the electrode pattern 155. However, in a multiple flow front capillary, such as illustrated in FIG. 5, the electrodes 164 may be placed in a location, such as spaced apart in the lateral ends of the sample chamber 150, that ensures the electrode pattern 155 located between the electrodes 164 is sufficiently covered by sample fluid.

FIG. 5 depicts the general manner in which a sample of fluid entering the sample chamber 150 at opening 148 spreads as the sample fills the sample chamber 150. In the depicted example, the sample fluid enters at the approximate center of the sample chamber width and spreads in a generally T-shaped nature, moving generally inward and then generally outward along the directions 168. As the sample fills the depths of sample chamber 150 up to about the vent openings 170, 171, the sample flows in a direction that is generally perpendicular to the longitudinal axis 102 of test strip 100. By simultaneously filling in two directions, the sample chamber 150 can fill quicker than similarly sized sample chambers that fill in only one direction.

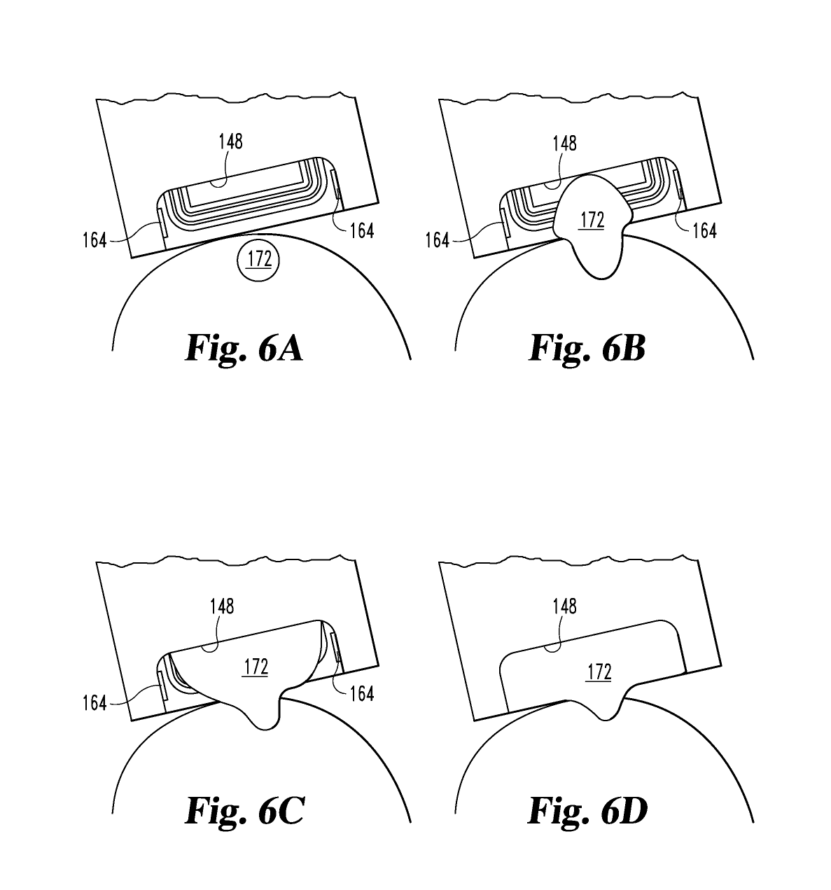

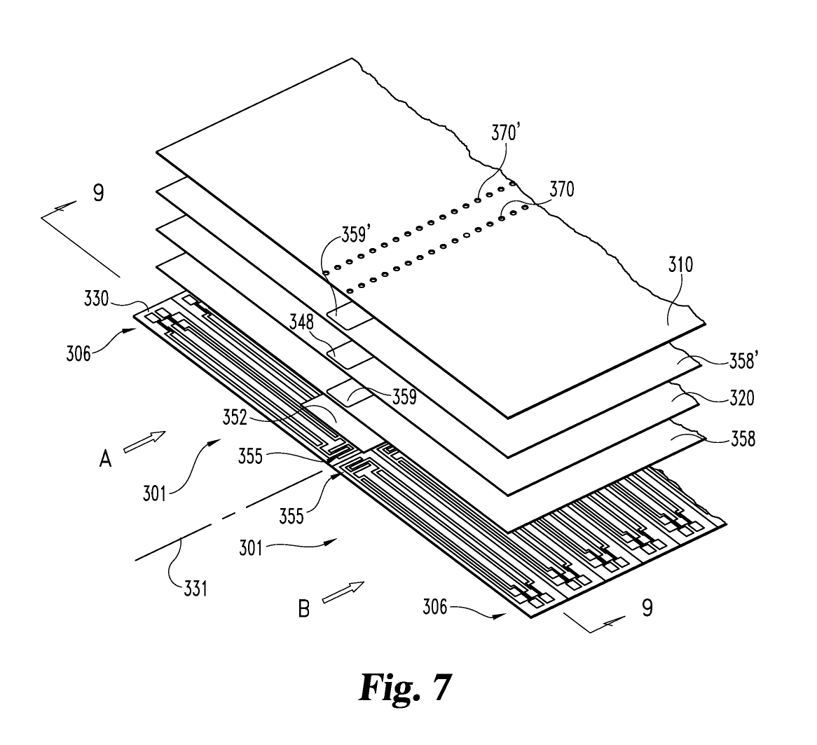

FIGS. 6A-6D also depict, although in an alternative presentation, the manner in which a fluid sample fills the sample chamber 150 in two-dimensions. FIG. 6A depicts the droplet of sample fluid prior to contact with the sample chamber 150. FIG. 6B depicts the droplet of sample fluid 172 spreading inward into the sample chamber 150 and at the point the droplet of sample fluid 172 begins arrives adjacent the downstream edge of the cutout portion 148. FIG. 6C depicts the droplet 172 spreading outwardly in two directions and along the downstream edge of the cutout portion 148. FIG. 6D depicts the droplet 172 contacting the sample sufficiency electrodes 164 and continuing to fill the sample chamber 150.

Embodiments of the present invention exhibit improved sample acquisition characteristics. For example, unexpectedly fast fill times were realized when testing embodiments of the disclosed invention. Fast fill times reduce the amount of time required by users to test sample fluid. Fast fill times also result in less evaporation, which, for example, reduces the total amount of blood that must be expressed from a user. Smaller sample sizes enable the user to obtain blood from alternate test sites that may not be as vascular but do not result in as much pain. In some embodiments, the lower surface of the upper substrate layer 110 (the surface facing the sample chamber 150) is comprised of hydrophilic material, which can further enhance the ability of the sample chamber 150 to rapidly fill with fluid. In other embodiments, the bottom of the sample chamber 150 is coated with a reagent layer 152 that is hydrophilic, which can also enhance the ability of the sample chamber to rapidly fill with fluid.

It was discovered that the aspect ratio of the sample chamber 150 (the ratio equal to the sample chamber depth 146 divided by the sample chamber width 142) affected the fill times of the sample chamber 150. In general, smaller aspect ratios result in quicker fill times than larger aspect ratios. Sample chambers with aspect ratios less than 1.0 were capable of two-dimensional filling (see, e.g., FIGS. 5-6D), which decreased the total time required to fill the sample chamber. To achieve two-dimensional filling with the sample fluid contacting the downstream edge of the cutout portion 148 prior to spreading out sideways along the width of the sample chamber 150, it is desirable to have the sample chamber depth 146 less than the sample chamber width 142. Stated differently, aspect ratios of less than 1.0 provide for rapid fill times of the sample chamber 150. Aspect ratios greater than 1.0 can result in incomplete filling of the sample chamber 150 and can potentially result in air being trapped over the electrode pattern 155 resulting in testing errors. In one embodiment, the sample chamber 150 has an aspect ratio of 0.2 with, for example, the sample chamber depth 146 being one millimeter (1 mm) and the sample chamber width 145 being five millimeters (5 mm). In other embodiments, the aspect ratio of the sample chamber 150 is at least one-ninth (1/9, approximately 0.1) and at most one-third (1/3, approximately 0.3). In an alternate embodiment, the aspect ratio is at least one-sixth (1/6, approximately 0.17) and at most one-quarter (1/4, or 0.25).

In addition to the aspect ratio, the overall dimension (size) of the sample chamber affects how quickly the sample chamber fills. In general, less fluid is required to fill a small sample chamber than a large sample chamber, indicating that the time to fill a small sample chamber should be less than a larger sample chamber. However, it was discovered that certain smaller dimensions for sample chamber height 144 would result in increased fill times. For example, when sampling whole blood, the fill times for the sample chamber 150 increases as the sample chamber height 144 decreases below one hundred micrometers (100 μm).

It is expected that the fill times for the sample chamber 150 will be higher when dosing with sample fluid having higher than nominal hematocrit levels, e.g. 65-85%. Sample chambers adapted to sample and test serum, plasma, or aqueous solutions can use a smaller sample chamber height and can potentially achieve faster fill times.

Although FIGS. 5-6D depict a droplet of sample fluid being applied to the center of the sample chamber, it should be appreciated that the droplet may be applied anywhere along the width of the wider front opening 151. The ability to place the sample anywhere along the width of the wider front opening 151 is advantageous for all users, especially those with diminished eyesight, which is not uncommon with diabetics, since someone with diminished eyesight may not be able to place the sample at an exact location along the width of the test strip. As such, advantages are realized if the width 142 of the test strip 100 is sufficiently large to allow impaired users to easily use the test strip 100. In one embodiment, the width 142 of the sample chamber 150 is at least three millimeters (3 mm) and at most nine millimeters (9 mm). In another embodiment, the width 142 of the sample chamber 150 is at least four millimeters (4 mm) and at most six millimeters (6 mm). In still another embodiment, the width 142 of the sample chamber 150 is five millimeters (5 mm).

While the ability of the sample chamber 150 to fill two-dimensionally enhances the ability of the sample chamber 150 to fill rapidly, the relatively small size of the sample chamber 150 further enhances its ability to fill rapidly and minimizes the amount of sample fluid required for testing. For example, the more fluid required for testing, the more time will be required to fill the sample chamber given the same or similar flow rate of fluid into the sample chamber. However, too small of a sample volume can, through evaporation, result in relatively large sample size variations during testing, which can adversely impact test results. In balancing these and other factors, alternate embodiments include sample chamber volumes that are at most one thousand nanoliters (1,000 nl), five hundred nanoliters (500 nl), and one hundred nanoliters (100 nl).

For a given sample chamber width 142, a larger sample chamber depth 146 increases the volume, increases the aspect ratio and increases sample chamber fill times of the sample chamber 150. However, the sample chamber depths 146 that are too small can have adverse effects during the manufacturing process. For example, when producing test strips using the methods described in relation to, for example, FIG. 7 below, small errors in separating the head-to-head oriented test strips will result in large variations in sample chamber volume when the sample chamber depth is small. Embodiments include the sample chamber depths 146 equal to at most one and one-half millimeters (1.5 mm). Alternate embodiments include the sample chamber depths 146 equal to at most one millimeter (1.0 mm).

In one embodiment, at least the upper substrate layer 110 is transparent in the region of the sample chamber 150 to provide visual feedback to the user while the sample chamber 150 fills with fluid. Once the user verifies that the sample chamber 150 is filled with fluid, by visual confirmation through the transparent upper substrate layer 110, the user can remove the supply of sample fluid from the sample chamber 150 to avoid perturbing the fluid in the sample chamber 150 during testing, which could adversely affect the test results.

The electrode pattern 155 is typically formed on one substrate layer—the lower substrate layer 130. However, alternate embodiments include opposing (otherwise referred to as “facing”) sample end electrode patterns that are formed on two substrate surfaces that face one another in the assembled test strip. This arrangement can assist in further reducing test strip width. However, if a test strip is too narrow it can be difficult for users to handle, especially impaired users.

Forming the electrode pattern on a single substrate can help reduce variations in electrode separation, which can adversely affect test strip performance and test results. The separation distance between facing electrodes (electrodes that are formed on two facing substrate layers and face one another) changes with variations in sample chamber height, such as variations in sample chamber height caused by varying the thickness of spacer 120 or adhesion layers 158 and 158′. However, variations in sample chamber height do not affect the separation between electrodes formed on the same substrate. This feature can be particularly beneficial when producing test strips intended for use without entry of a batch-related code (generally related to a predetermined correction factor) prior to use. Further advantages of coplanar electrodes (electrodes located on the same plane, such as when they are formed on the same substrate layer) can be realized during manufacture since one or more simple changes can be made to the electrode pattern design to adjust the geometry, size or spacing of electrodes as needed or desired.

Furthermore, in other embodiments, including the electrode pattern 155 on a single substrate (e.g., the lower substrate layer 130) allows a portion or all of the other substrate layer (e.g., the upper substrate layer 110) to be transparent or translucent, which assists the user to clearly identify the sample location and obtain visual confirmation that the sample chamber is properly filling and/or filled. The ability to obtain visual feedback of the sample chamber filling with fluid provides advantages in helping the user know to stop trying to fill a full sample chamber, since attempting to fill an already full sample chamber can perturb the sample and adversely affect the test results.

In other embodiments, translucent layer 110 may be used as a light guide or light pipe to carry illumination from a light source, e.g., from a strip port on a meter, placed adjacent to the contact end of the biosensor. The illumination allows a user to visualize the dose area 148 of the strip in low light conditions. The light is emitted along edge 112 and can provide illumination to visualize a sample to be applied.

Further advantages of a transparent or translucent upper substrate layer, also referred to commonly as a cover, lid, or roof by those of ordinary skill in the art, are set forth in U.S. Pat. No. 5,997,817 to Crismore, the disclosure of which is incorporated herein by reference.

Referring to FIG. 2, the upper substrate front edge 112, the spacer front edge 122, and the lower substrate front edge 132 are generally aligned. Manufacturing efficiencies can be realized by aligning the edges 112, 122, and 132 in this way, especially when using a 2-up manufacturing process as described with respect to, for example, FIG. 7 below, since a single vertical cut can be made through the upper substrate layer 110, the spacer 120, and the lower substrate layer 130 when test strips are separated from one another during the singulation process.

FIG. 7 depicts an alternate manufacturing technique in which test strips are manufactured in a head-to-head arrangement, otherwise referred to as a “2-up” manufacturing technique. With the 2-up manufacturing process, a plurality of electrode patterns 301 are arranged in two columns (one set of electrode patterns in column A and one set in column B) on an elongated layer (tape) of a lower substrate 330. The electrode patterns in each column are arranged in a side-by-side manner, and as will be appreciated by a person of ordinary skill in the art in view of this disclosure, it is generally useful, although not required, that individual patterns in one column are generally opposite to individual patterns in the other column.

The sample chamber electrode patterns 355 are located near each other and near the center of the lower substrate strip 330, with the contact pads 306 being spaced apart from one another and located near the opposite edges of the lower substrate strip. In the depicted embodiment, the electrode patterns are all similar; however in alternate embodiments at least some of the electrode patterns are different from other electrode patterns.

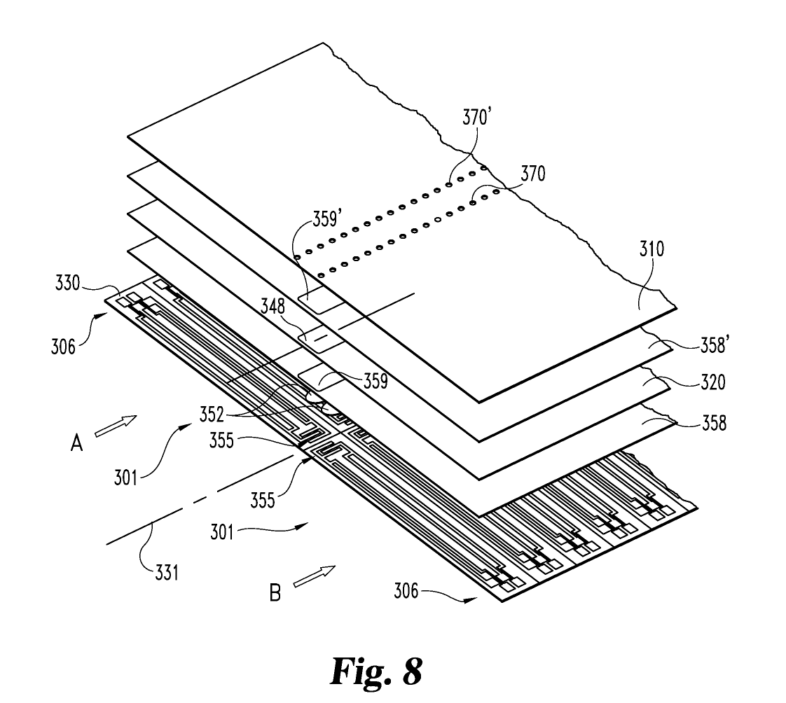

A layer of the reagent 352 is preferably applied in a stripe over the two sample chamber electrode patterns 355 simultaneously and dried to a thickness of, for example, two to ten micrometers (2-10 μm). The reagent layer 352 may be applied using a high speed coating process such as a modified slot die coater with vacuum assist, or may be applied using, for example, blade coating, dispensing, inkjet coating, screen printing and rotary screen printing. An exemplary alternate embodiment having more discrete deposition of the reagent layers 352 is illustrated in FIG. 8.

By employing a 2-up manufacturing technique, twice as many test strips are produced in the same length (as measured perpendicular to the test strip longitudinal axis 102, see FIG. 1) of the lower substrate tape 330 as compared to a single column having a plurality of side-by-side oriented electrode patterns, helping to reduce costs, reduce waste, and increase output.

One elongated strip (tape) forms the spacer layer 320 to cover both columns of electrode patterns. The spacer layer 320 is attached to the top of the lower substrate layer 330, either before or after application of the reagent 352. Alternatively, two elongated strips (tapes) form two spacer layers wherein two separate strips of spacer material are individually attached to the lower substrate layer 330, one for column A and one for column B. In this embodiment (not shown), the front edges of both spacer layers can be aligned along a centerline 331.

The spacer 320 includes a plurality of cutout portions 348 arranged along centerline 331. Cutout portions 348 in spacer 320 can be formed by a variety of techniques. One technique of forming cutout portions 348 may include die cutting. When the spacer 320 is assembled with the lower substrate layer 330, the cutout portions 348 will form the perimeters of the sample chambers.

An upper substrate layer 310 is attached to the top of the spacer layer 320. The upper substrate layer 310 is a single, continuous layer. In the illustrated embodiment, the lower substrate 330, the spacer layer 320, and the upper substrate 310 are attached with the adhesive layers 358 and 358′. The adhesive layers may be elongated strips of PSA, adhesive tape, sprayed-on adhesive stripes, hot melt, co-extruded, or heat seal layers. In the illustrated embodiment, adhesive layers 358 and 358′ include a plurality of cutout portions 359 and 359′ arranged along the centerline 331 and corresponding to cutout portions 348. The cutout portions 359 and 359′ are sized similarly to cutout portions 348. Alternatively, the top adhesive layer 358 may be a solid layer without any openings or cutouts. Further, a hydrophilic coating may be placed between the spacer 320 and the top adhesive layer 358 to prevent direct contact between the adhesive layer 358 and the reagent 352. The hydrophilic coating is chosen to impart a hydrophilic nature to the internal surface of the sample chamber to encourage flow of an aqueous sample, such as blood, into the sample chamber. Alternatively, spacer layer 320 may be a double sided adhesive tape, obviating the need for separate adhesive layers 358 and 358′. Alternative manners of fixing layers of a biosensor without adhesion layers include heat sealing, laser sealing, cold sealing, etc.

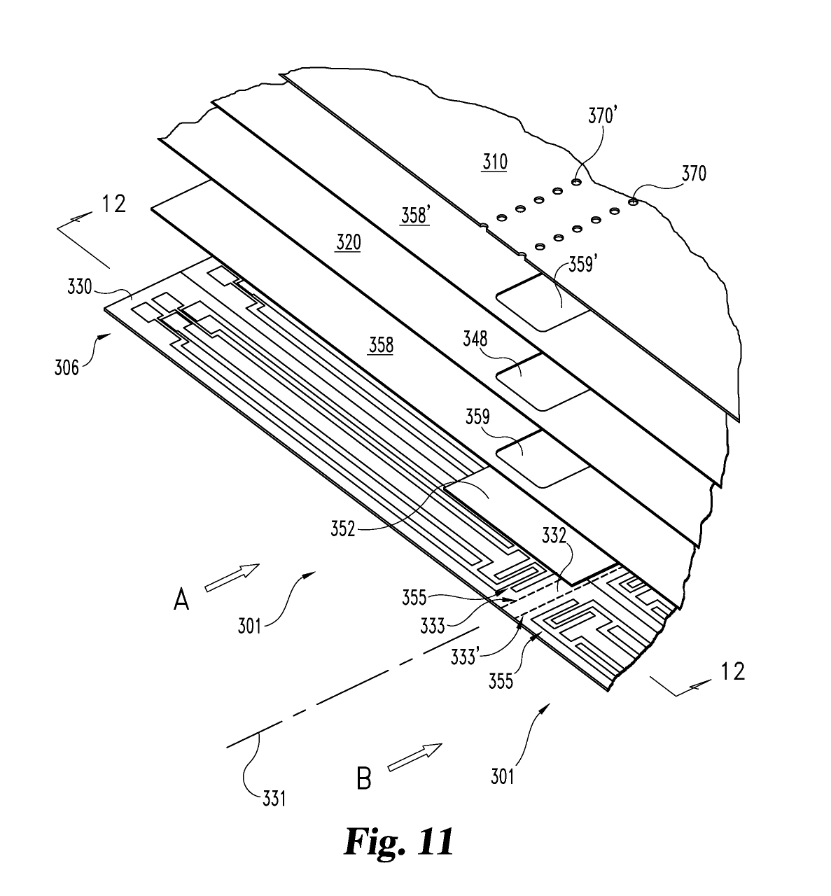

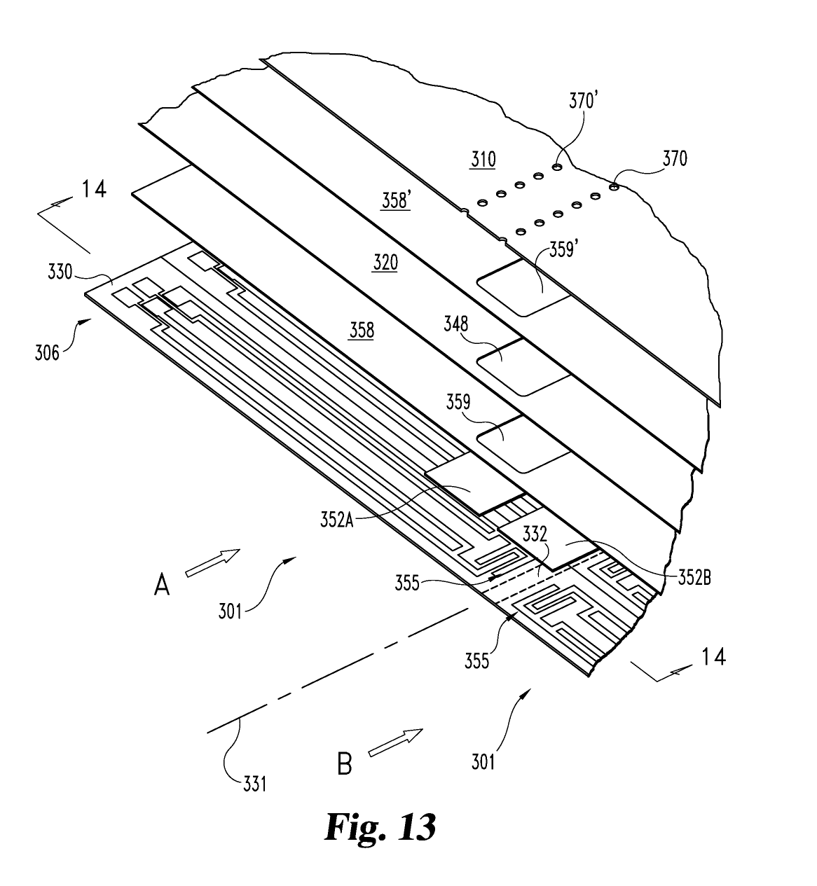

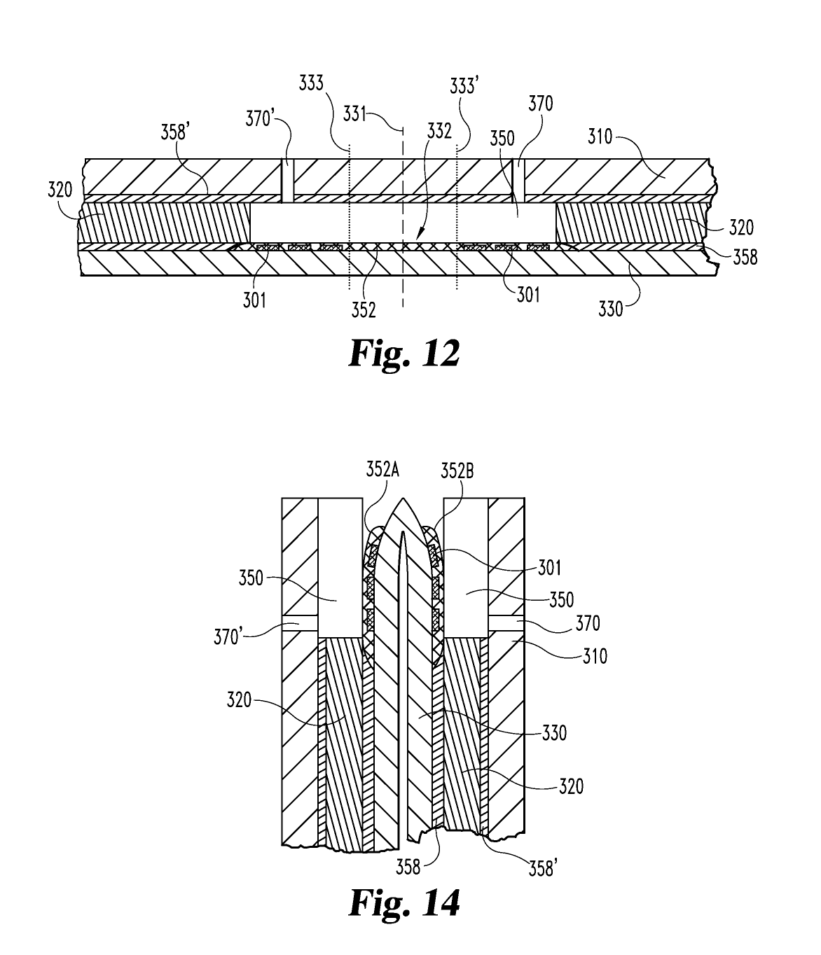

After the lower substrate 330, the reagent 352, the spacer layer 320 and the upper substrate 310 are combined and laminated together, the sheet or roll is separated into individual test strips. The test strips in column A are separated from the test strips in column B (the sample chambers of the head-to-head oriented test strips are separated from one another approximately along the centerline 331) typically using a single cut along centerline 331, and the test strips in adjacent rows (side-by-side oriented test strips) are separated from one another between the electrode patterns. An alternative embodiment discussed below relating to FIGS. 11-12 employs multiple cuts.

As discussed above, when a broad field laser ablation technique is employed to form the electrode patterns 355, it is possible to configure the ablation technique so that multiple patterns are formed from each laser pulse. In a 2-up manufacturing process, the multiple patterns can be the facing patterns of columns A and B, and if the laser lens is sufficiently broad (and an appropriate mask is provided), the multiple patterns may include laterally adjacent patterns within a particular column as well as oppositely adjacent patterns between the columns. In one embodiment, four patterns are formed in a single pulse. In other embodiments, six or more patterns are formed in a single pulse. In addition to throughput advantages mentioned above, the ability to form the electrode patterns that oppose each other between columns A and B in a single ablation pulse also helps keep the spacing variation between the columns at a minimum. This helps control variation seen in the capillary width 146 by using the electrode pattern to position and control the placement of the spacer 120. The precise spacing of the electrode patterns can be used as a datum for locating and placing other components in the strip.

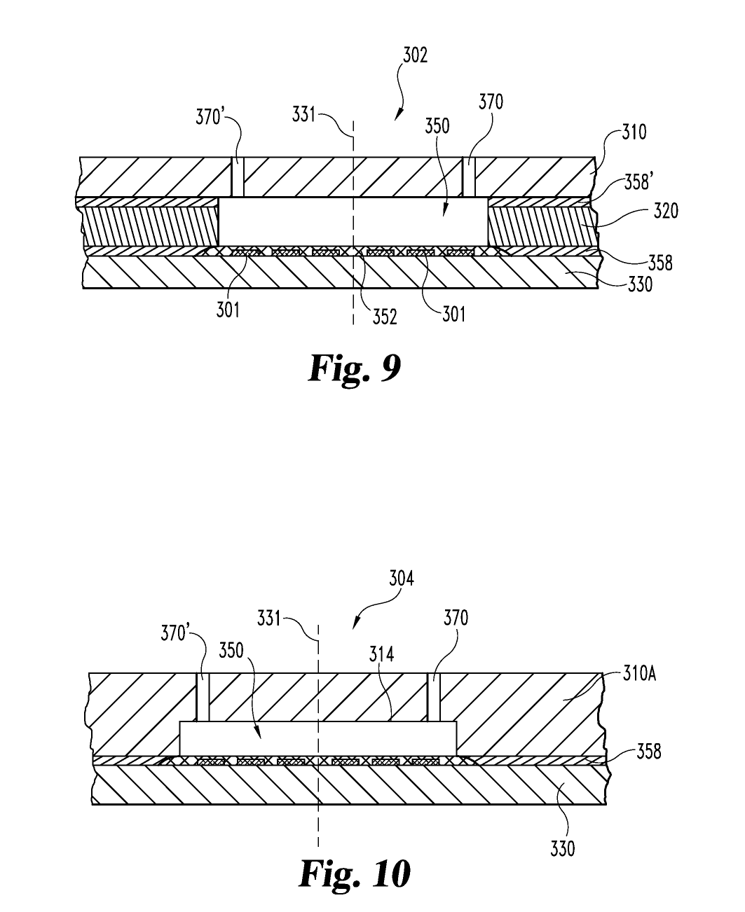

Depicted in FIG. 9 is a cross-sectional view of a head-to-head test strip pair 302 after attaching the layers depicted in FIG. 7 to one another. The upper substrate 310 is attached to an adhesive layer 358′, which is attached to the spacer layer 320, which is attached to another adhesive layer 358, which is attached to lower substrate layer 330. Located atop lower substrate 330 are electrode pattern 301 and reagent layer 352. Sample chamber 350 is vertically defined in the space between upper substrate layer 310, adhesive layers 358 and 358′, spacer layer 320, and lower substrate layer 330. The perimeter of the sample chamber 350 is defined by the cutout portions 348 of the spacer layer 320 with the centerline 331 dividing the cutout portions 348 to form two sample chambers 350.

Depicted in FIG. 10 is a head-to-head test strip pair 304 with an upper substrate layer 310A according to another embodiment. The use of the upper substrate layer 310A obviates the need for the spacer layer 320 depicted in FIG. 9. Upper substrate layer 310A includes a recess, for example groove 314, which, together with the lower substrate layer 330 and the adhesive layer 358, define sample chamber 350. Sample chamber 350 is divided by centerline 331. The depth and width of groove 314 can be accurately controlled during the manufacturing process. As such, the size of sample chamber 350 can be accurately controlled and the need to include, align and attach a spacer layer 320 is eliminated. In one embodiment, groove 314 is formed by laser ablation. In alternate embodiments, groove 314 is formed using a calendering process, which allows the finished test strips to maintain a flat profile for efficient stacking In still further embodiments, groove 314 is formed by skiving or by embossing.

Depicted in FIGS. 11 and 12 is an alternate embodiment manufacturing technique (which may also be referred to as a modified 2-up manufacturing process) for manufacturing test strips in a head-to-head arrangement. The electrode patterns 355 in FIG. 11 are spaced further apart than the electrode patterns 355 in FIG. 8 and the increased distance defines a margin 332 (sometimes referred to as an alley) extending between the two sets of electrode patterns 355 and bounded generally, for purposes of illustration, by lines 333 and 333′. The cutout portions 348 in spacer 320 are spaced further apart or are elongated a greater amount than the cutout portions 348 in FIG. 8 and the increased distance corresponds to the margin 332. Similarly, the cutout portions 359 and 359′ in adhesive layers 358 and 358′ are likewise spaced further apart than the cutout portions 358 in FIG. 8 and the increased distance corresponds to the margin 332. After the lower substrate 330, the reagent 352, the spacer layer 320, the adhesive layers 358 and 358′, and the upper substrate 310 are combined and laminated together, the test strips in column A are separated from the test strips in column B and the test strips in adjacent rows are separated from one another between the electrode patterns.

In one embodiment, three cuts are made to separate column A from column B and to form the forward edges of the test strips, for example, the forward edges 112, 122, and 132 depicted in FIG. 2. A cut is made in the margin 332 near the centerline 331. Another cut is made along line 333 to form the forward edges of the test strips in column A and still another cut is made along line 333′ to form the forward edges of the test strips in column B.

In another embodiment, two cuts are made to separate column A from column B, and to form the forward edges of the test strip. A cut is made along line 333 adjacent the electrode patterns 355 in column A to form the forward edge of the test strips in column A and separate column A from the margin 332 and column B. Another cut is made along line 333′ to form the forward edge of column B and separate column B from the margin 332.

The embodiments with margin 332 between electrode patterns 355 (described with respect to FIG. 11) can be useful when a single cut to separate the test strips in columns A from the test strips in columns B and form the sampling ends of the test strips is not preferred.

Referring to FIGS. 13 and 14, in an alternate embodiment the layer 352 of reagent material includes two different reagents—reagent layer 352A positioned over the electrode patterns 355 of column A and reagent layer 352B positioned over the electrode patterns 355 of column B. In this embodiment, the head-to-head pair of electrode patterns remain attached to one another (the test strips in Column A remain attached to the test strips in column B) while the test strips in adjacent rows (side-by-side oriented test strips) are separated. In other words, the test strips in column A are not fully separated from the test strips in column B, and test strip pairs are formed with each pair of test strips arranged in a head-to-head manner. Each test strip pair may be folded to place the contact pads of the test strip from column A adjacent the contact pads of the test strip from column B, and to place the sampling end of the test strip from column A adjacent to and facing the same direction as the sampling end of the test strip from column B. Using this type of head-to-head test strip pair, a dual-use biosensor is provided in which a user can apply a sample of bodily fluid to both test strips simultaneously. Since the reagents in the two sample chambers are different, each sample chamber will test for a different analyte, and two separate tests will be performed after lancing the skin only once. As an example, one test strip could test for glucose while the other test strip tests for ketones or triglycerides. In one embodiment, a blood filtering media is provided within the dual sample chamber area prior to folding the pair together, in order to prevent blood and reagent mixing between the chambers.

It should be appreciated that the sample chambers in each of the head-to-head oriented pair of test strips should be exposed when the pair of test strips are bent along centerline 331. Alternative manufacturing techniques can be used to ensure both sample chambers are exposed. For example, in one embodiment, one of the substrate layers, e.g. the top layer, is fully separated along centerline 331 during manufacture while the other substrate layer, e.g. the bottom layer, is either unmodified or modified to predictably bend about centerline 331. In an alternate embodiment, one of the substrate layers is modified, such as through perforations or partial cutting to be easily separated by the user along centerline 331 while the other substrate is modified, such as by scoring, denting or crimping, to predictably bend or separate about a straight line, for example, centerline 331. In still another embodiment, both the upper substrate layer 310 and the lower substrate layer 330 are modified to allow the head-to-head test strips to be folded in either direction, i.e., the user may choose to bend the head-to-head pair of test strips to have the upper substrate layers 310 of the two test strips positioned adjacent one another or to have the lower substrate layers 330 of the two each test strips positioned adjacent one another.

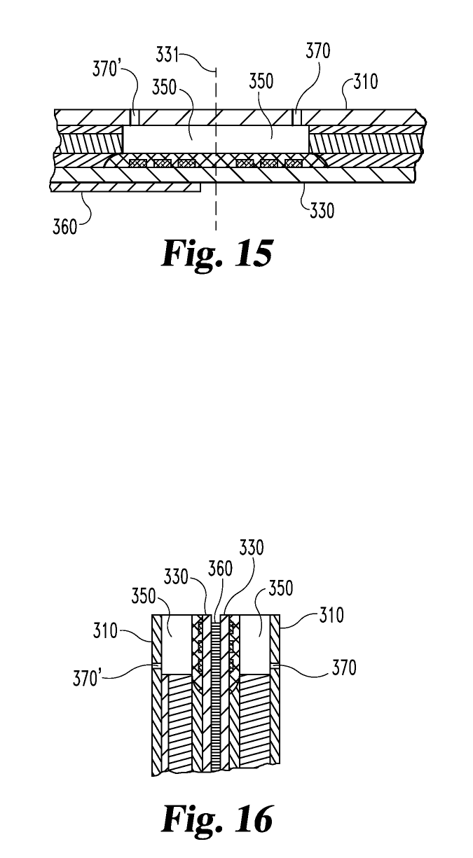

FIGS. 15-16 show further alternative embodiments of a dual-use biosensor. According to FIGS. 15 and 16, an adhesion layer 360 can be provided on the bottom layer 330 on only one side of centerline 331. Columns A and B are then fully separated about the centerline 331 and affixed by adhesion layer 360 in an orientation similar to the folded-over embodiment above (FIG. 14), as shown in FIG. 16. In such embodiments, potential variability from having the user fold the bottom layer is avoided, as is any effort of perforating the top layer and/or scoring, denting or crimping the bottom layer to define a folding line.

The embodiments of dual-use biosensors discussed herein comprise a single biosensor that has two different electrochemical analyses which can be performed. Each sample chamber for such a dual-use biosensor has a different reagent layer configured for a particular analysis. During manufacture in a 2-up process, precise and discrete reagent layer deposition, such as by ink jetting, is used in order to provide the different reagent layers either in a continuous stripe or discretely over each electrode pattern.

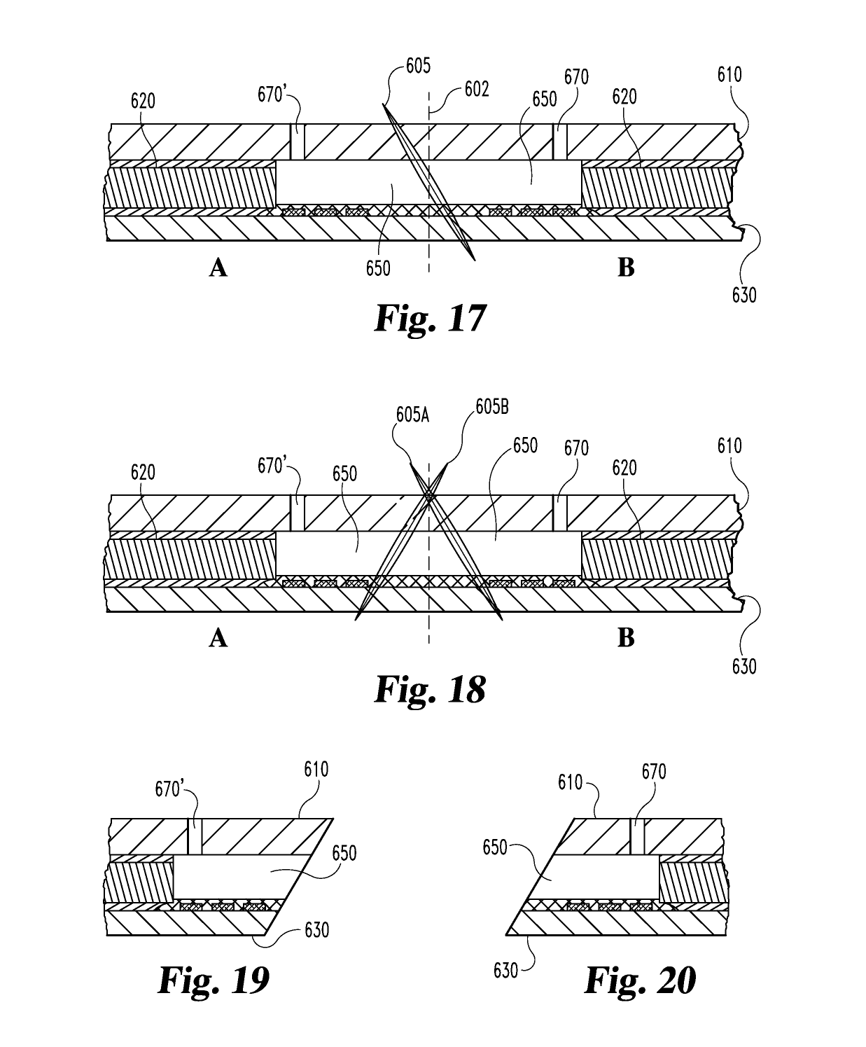

In one embodiment, an angled cutting tool (angled with respect to the upper and/or lower substrate layer) is used to separate columns A and B. As shown in FIGS. 17-20, an angled cutting tool 605 produces test strips in which the upper substrate layer 610 and the lower substrate layer 630, surrounding spacer 620 and capillary chamber 650, extend different distances from the centerline 602. The overhang distances of column A are the converse of column B when a single angular cut is made, such as would result from a cut according to FIG. 17. When using two cutting tools 605A and 605B as shown in FIG. 18, two opposite angular cuts are made in opposite orientations so that the overhang configuration is generally the same for strips singulated from each column. Illustrations of exemplary embodiments of disparate overhang distances are shown in FIGS. 19 and 20.

In certain embodiments of the present invention, the lower substrate layer (e.g., lower substrate layer 130) is generally constructed of a 10 mil (0.01 inch) strip of insulating substrate, for example a polyethylene terephthalate (PET, for example, Melinex® manufactured by E. I. Du Pont de Nemours & Co.), polyethylene naphthalate (PEN), polyvinyl chloride (PVC), polyimide (PI) or polycarbonate (PC) film. In other embodiments, the electrodes and electrode patterns (e.g., sampling end electrode pattern 155) are formed on top of the lower substrate layer using laser ablation or other techniques appropriate for creating well-defined electrode patterns in a relatively small test area. The electrodes may be made from, for example, sputtered, printed or ink jetted gold, palladium, platinum or carbon. The spacer layer (e.g., spacer layer 120) can be opaque and can include printing or labeling, such as labeling that identifies the test strip and/or directions for using the test strip.

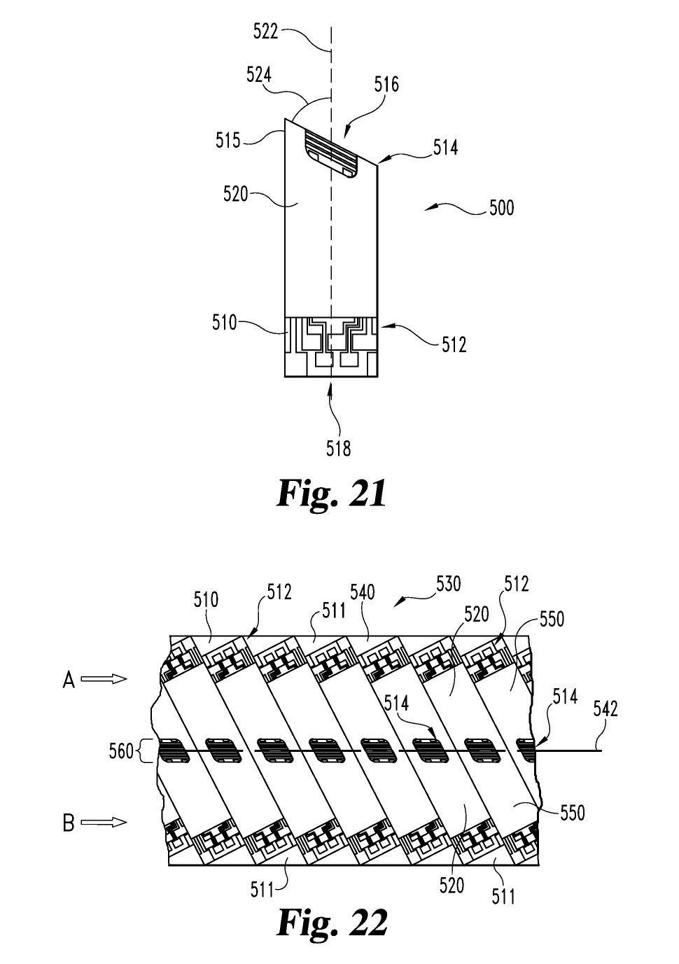

Depicted in FIG. 21 is a test strip 500 according to another embodiment of the present invention. Test strip 500 includes a lower substrate layer 510. Test strip 500 also includes a contact pad pattern 512 and an electrode pattern 514 provided on top of the lower substrate 510. A reagent layer 515 (which is depicted as being transparent) overlies electrode pattern 514 and the portion of lower substrate layer 510 in the vicinity of the electrode pattern 514 not covered by electrode pattern 514. The electrode pattern 514 is located at the sampling end 516 while the contact pad pattern 512 is located at the test meter connection end 518. A spacer layer 520 overlies the substrate layer 510, contact pad pattern 512 and electrode pattern 514. Test strip 500 further includes an upper substrate layer, although the upper substrate layer is not depicted in FIG. 21 to provide a clearer view of the electrodes and spacer layer.

The sampling end 516 is not perpendicular to a longitudinal axis 522 of test strip 500. Instead, sampling end 516 is inclined at a nonperpendicular angle 524 from the longitudinal axis 522, i.e., angle 524 is not equal to ninety (90) degrees. For a specified lateral test strip width, the angled sampling end 516 presents an even wider chamber opening for the user to apply a sample than a typical test strip with a sampling end that is perpendicular to the longitudinal axis. Some patients find the longer, angled edge easier to use, especially patients with reduced manual dexterity. The wider chamber opening of the angled sampling end 516 can be particularly advantageous when used with a relatively narrow test strip, for example, test strips with a lateral width equal to five millimeters (5 mm) or less.

Depicted in FIG. 22 is a plurality of partially constructed test strips 530 during a manufacturing process for producing test strip 500 according to one embodiment of the present invention. Contact pad pattern 512 and sampling end electrode pattern 514 are formed on an elongated tape 540 of lower substrate 510. The contact pad patterns 512 and electrode patterns 514 are formed on top of the elongated lower substrate tape 540 using, for example, laser ablation techniques. The tape 540 defines a longitudinal axis 542 and the electrode patterns (which include electrode pattern 514 and contact pad pattern 512) are angled with respect to the longitudinal axis 542. Two elongated tapes 550 of material that form spacer layer 520 are layered on top of the electrode patterns and the lower substrate tape 540. A reagent layer stripe 560 (depicted as being transparent) is layered over the electrode patterns 514 and the elongated lower substrate tape 540 that form the sample chambers. A cutting device that produces a ratchet-cut removes the excess material 511 of the lower substrate tape 540. A similar ratchet cutting device may also be used to produce an edge of each elongated spacer layer tape 550.

After the elongated spacer tape 550 and reagent layer stripe 560 are attached to the elongated lower substrate layer 540 and the electrode patterns, an elongated upper substrate tape is applied (not depicted in order to show detail of the other portions of the test strips). The test strips are separated from one another using a singulation process that separates the test strips in column A from the test strips in column B along the longitudinal axis 542. Adjacent test strips are separated also by a straight cut along the lateral sides of each strip, although the excess material 511 is first separated from each column with, for example, a ratchet-cut technique.

While illustrated examples, representative embodiments and specific forms of the invention have been illustrated and described in detail in the drawings and foregoing description, the same is to be considered as illustrative and not restrictive or limiting. The description of particular features in one embodiment does not imply that those particular features are necessarily limited to that one embodiment. Features of one embodiment may be used in combination with features of other embodiments as would be understood by one of ordinary skill in the art, whether or not explicitly described as such. Dimensions, whether used explicitly or implicitly, are not intended to be limiting and may be altered as would be understood by one of ordinary skill in the art. Only exemplary embodiments have been shown and described, and all changes and modifications that come within the spirit of the invention are desired to be protected.

What is claimed is:

1. A method of manufacturing biosensor test strips, comprising:
forming multiple pairs of similar electrode sets in a line along the interior of a continuous substrate, each pair of electrode sets comprising a first electrode set and a paired, second electrode set in a head-to-head arrangement, the first electrode sets being aligned to form a first column along the substrate and the second electrode sets being aligned to form a second column along the substrate, each first electrode set being adjacent but spaced apart a predetermined distance from the paired second electrode set;
depositing a reagent that at least partially covers each of the electrode sets;
separating the first electrode sets from the second electrode sets; and
separating each first electrode set from each other first electrode set, and separating each second electrode set from each other second electrode set by using a single or multiple cuts,
thereby forming individual test strips.

2. The method of claim 1 in which the continuous substrate has a lateral width corresponding to about twice the length of the test strips.

3. The method of claim 1 in which said depositing a reagent comprises depositing a continuous layer of reagent which covers each of the electrode sets.

4. The method of claim 1 in which said depositing a reagent comprises depositing a first, continuous layer of reagent which covers each of the first electrode sets, and a second, continuous layer of reagent which covers each of the second electrode sets.

5. The method of claim 4 in which the reagent of the first layer is different from the reagent of the second layer.

6. The method of claim 1 wherein said separating the first electrode sets from the second electrode sets comprises an angular cut between the first and second electrode sets.

7. The method of claim 1 wherein said separating the first electrode sets from the second electrode sets comprises making two angular cuts between the first and second electrode sets.

8. The method of claim 1 which further comprises laminating a spacer layer and a cover layer on top of the continuous substrate, the spacer layer having open portions aligned with each of the electrode sets, the open portions corresponding to capillary chambers in the completed test strips, wherein said separating forms test strips having capillary chambers extending from an end of each test strip at least to the electrode set of the test strip.

9. A method of manufacturing biosensor test strips, comprising:
forming first and second columns of similar head-to-head electrode sets on a continuous substrate;
depositing a first continuous layer of reagent that at least partially covers the electrode sets in the first column;
depositing a second continuous layer of reagent that at least partially covers the electrode sets in the second column; and
separating the substrate into individual test strips, said separating including cutting the substrate between the two columns of head-to-head electrode sets.

10. The method of claim 9, wherein said depositing said first and said second continuous layers of reagent includes depositing a single continuous layer of reagent that at least partially covers both of the two columns of head-to-head electrode sets.

11. The method of claim 9, wherein the first and second continuous layers of reagent comprise different reagents.

12. The method of claim 9, wherein said cutting includes making an angular cut.

13. The method of claim 9, wherein said cutting includes making two opposite angular cuts.

14. The method of claim 9, further comprising:
laminating a continuous spacer layer and a continuous cover layer on top of the continuous substrate, the continuous spacer layer having cutout portions aligned with each of the head-to-head electrode sets; and
wherein said cutting includes creating capillary chambers by cutting the substrate and the cover layer at the cutout portions.

15. The method of claim 14, further comprising:
forming vent openings in the continuous cover layer; and
aligning the vent openings with the cutout portions to create vents for the capillary chambers.

16. The method of claim 9, wherein the electrode sets include coplanar electrodes.

17. The method of claim 9, wherein said head-to-head electrode sets are spaced apart a predetermined distance, and said cutting includes making a single cut to form two biosensor test strips.

18. The method of claim 17, wherein said cutting includes making an angular cut.

19. The method of claim 9, further comprising:
said cutting including making a first cut adjacent a first electrode set at a position to form an end of a first biosensor test strip configured to receive a bodily fluid sample, said cutting further including making a second cut adjacent the respective second electrode set at a position to form an end of a second biosensor test strip configured to receive a bodily fluid sample.

20. The method of claim 19, wherein said cutting includes making first and second angular cuts.

21. A method of manufacturing biosensor test strips, comprising:
forming a column of electrode sets on a continuous substrate;
depositing a layer of reagent that at least partially covers the column of electrode sets;
laminating a continuous spacer layer defining a plurality of cutout portions on top of the continuous substrate, wherein a single cutout portion is aligned with each electrode set;
laminating a continuous cover layer having a plurality of vent openings on top of the continuous spacer layer to create a capillary chamber;
aligning at least two of the vent openings with each cutout portion of the spacer layer to create at least two vents for each capillary chamber; and
separating the substrate, the spacer layer, and the cover layer into individual biosensor test strips.

22. A method of manufacturing dual-use biosensor test strips, comprising:
forming first and second columns of similar head-to-head electrode sets on a continuous substrate;
depositing a first continuous layer of reagent that at least partially covers the electrode sets in the first column;
depositing a second continuous layer of reagent that at least partially covers the electrode sets in the second column;
folding the continuous substrate between the first and second columns of head-to-head electrode sets to form a plurality of paired electrode sets wherein each paired electrode set contains one electrode set from the first column and one electrode set from the second column; and
separating the continuous substrate into dual-use biosensor test strips, said separating including cutting the substrate between the paired electrode sets.
